(19) United States
(12) Patent Application Publication
(10) Pub. No.: US 2018/0276583 A1
(43) Pub. Date: Sep. 27, 2018

(54) METHODS AND DEVICES FOR IDENTIFYING ROOT CAUSES ASSOCIATED WITH RISKS IN SUPPLY CHAIN NETWORKS

(71) Applicant: WIPRO LIMITED, BANGALORE (IN)

(72) Inventor: SELVAKUBERAN KARUPPASAMY, CHENNAI (IN)

(73) Assignee: Wipro Limited

(21) Appl. No.: 15/468,674

(22) Filed: Mar. 24, 2017

(30) Foreign Application Priority Data
Mar. 21, 2017 (IN) 201741009912

(51) Int. Cl. G06Q 10/06; G06N 99/00

(52) U.S. Cl. CPC G06Q 10/0635; G06N 99/005

(57) ABSTRACT

A method of identifying root cause associated with risks in a supply chain network is disclosed. In one embodiment, the method includes performing natural language processing and text analysis on a user query to derive keywords, entities involved, and relationships between the keywords and the entities. The method further includes categorizing the user query into a risk category selected from a plurality of risk categories. The method includes creating a relationship mapping amongst at least one of a plurality of attributes associated with the risk category, in response to the categorization. The method further includes identifying, via the root cause identification device, a risk in the supply chain network based on the risk category and the relationship mapping. The method includes detecting a root cause from amongst a plurality of root causes associated with the risk.

### TECHNICAL FIELD

This disclosure relates generally to supply chain networks and more particularly to methods and devices for identifying root causes associated with risks in supply chain networks.

### BACKGROUND

Supply chain network is a network of actions followed or practiced to achieve a common goal. The main objective of the supply chain is customer satisfaction. However, when the supply chain network does not work properly or meets the desired objectives, customer satisfaction would suffer. As a result, entire supply chain network will incur huge losses. The challenge is such scenario is to analyze the loss of the supply chain network in order to identify the risk or disruption in the supply chain network.

The process of risk identification in some conventional systems is very time consuming and thus results in customer dissatisfaction or in a worst case scenario causes the customer to leave the supply chain network altogether.

### SUMMARY

In one embodiment, a method of identifying root cause associated with risks in a supply chain network is disclosed. The method includes performing, by a root cause identification device, natural language processing and text analysis on a user query to derive keywords, entities involved, and relationships between the keywords and the entities; categorizing, by the root cause identification device, the user query into a risk category selected from a plurality of risk categories; creating, by the root cause identification device, a relationship mapping amongst at least one of a plurality of attributes associated with the risk category, in response to the categorization; identifying, via the root cause identification device, a risk in the supply chain network based on the risk category and the relationship mapping; and detecting, via the root cause identification device, a root cause from amongst a plurality of root causes associated with the risk.

In another embodiment, a root cause identification device for identifying root cause associated with risks in a supply chain network. The root cause identification device comprises a processor; and a memory communicatively coupled to the processor, wherein the memory stores processor instructions, which, on execution, causes the processor to: perform natural language processing and text analysis on a user query to derive keywords, entities involved, and relationships between the keywords and the entities; categorize the user query into a risk category selected from a plurality of risk categories; create a relationship mapping amongst at least one of a plurality of attributes associated with the risk category, in response to the categorization; identify a risk in the supply chain network based on the risk category and the relationship mapping; and detect a root cause from amongst a plurality of root causes associated with the risk.

In yet another embodiment, a non-transitory computer-readable storage medium having stored thereon, a set of computer-executable instructions causing a computer comprising one or more processors to perform steps is disclosed. The steps comprising: performing, by a root cause identification device, natural language processing and text analysis on a user query to derive keywords, entities involved, and relationships between the keywords and the entities; categorizing, by the root cause identification device, the user query into a risk category selected from a plurality of risk categories; creating, by the root cause identification device, a relationship mapping amongst at least one of a plurality of attributes associated with the risk category, in response to the categorization; identifying, via the root cause identification device, a risk in the supply chain network based on the risk category and the relationship mapping; and detecting, via the root cause identification device, a root cause from amongst a plurality of root causes associated with the risk.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram illustrating a system for identifying a root cause associated with a risk in a supply chain network, in accordance with an embodiment.

FIG. 2 is a block diagram illustrating various modules within a memory of a root cause identification device configured to identify a root cause associated with a risk in a supply chain network, in accordance with an embodiment.

FIG. 3 illustrates a flowchart of a method identifying a root cause associated with a risk in a supply chain network, in accordance with an embodiment.

FIG. 4 illustrates a flowchart of a method of identifying a root cause associated with a risk in a supply chain network, in accordance with another embodiment.

FIG. 5 illustrates risk components and associated root causes in a product manufacturing supply chain network, in accordance with an exemplary embodiment.

FIG. 6 illustrates a block diagram of an exemplary computer system for implementing various embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

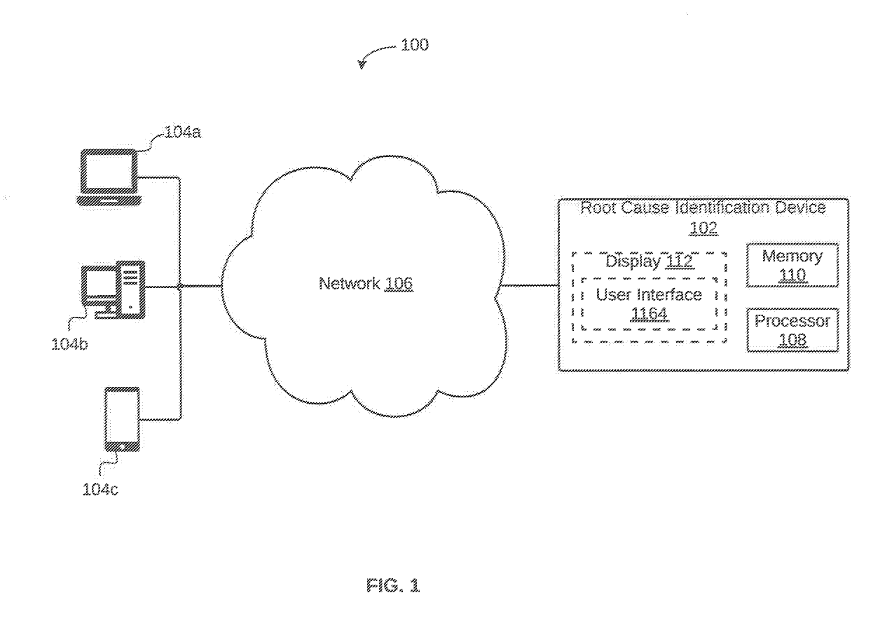

Additional illustrative embodiments are listed below. In one embodiment, a system 100 for identifying a root cause associated with a risk in a supply chain network is illustrated in FIG. 1. System 100 includes a root cause identification device 102 that identifies root cause for a risk in the supply chain network, which includes a plurality of computing devices 104 (for example, a laptop 104a, a desktop 104b, and a smart phone 104c) and a network 106. Other examples of plurality of computing devices 104, may include, but are not limited to a phablet and a tablet. Network 106 may be a wired or a wireless network and the examples may include, but are not limited to the Internet, Wireless Local Area Network (WLAN), Wi-Fi, Long Term Evolution (LTE), Worldwide Interoperability for Microwave Access (WiMAX), and General Packet Radio Service (GPRS).

Raw material suppliers, manufacturers, whole-salers, retailers, distributors, and customers in the supply chain network may access plurality of computing devices 104. The customers may vary depending upon the type of supply chain network. A customer facing an issue within the supply chain network may provide user queries via one or more of plurality of computing devices 104. A user query may either be an audio message or a text message that is provided via an SMS, an email, or through a messenger (for example, WHATSAPP® or FACEBOOK® messenger).

Root cause identification device 102 receives user queries provided by the customers in order to detect risks in the supply chain network and subsequently identify root cause for the detected risk, thereby providing a probable resolution to the detected risk. To this end, root cause identification device 102 includes a processor 108 that is communicatively coupled to a memory 110, which may be a non-volatile memory or a volatile memory. Examples of non-volatile memory, may include, but are not limited to a flash memory, a Read Only Memory (ROM), a Programmable ROM (PROM), Erasable PROM (EPROM), and Electrically EPROM (EEPROM) memory. Examples of volatile memory may include, but are not limited Dynamic Random Access Memory (DRAM), and Static Random-Access memory (SRAM).

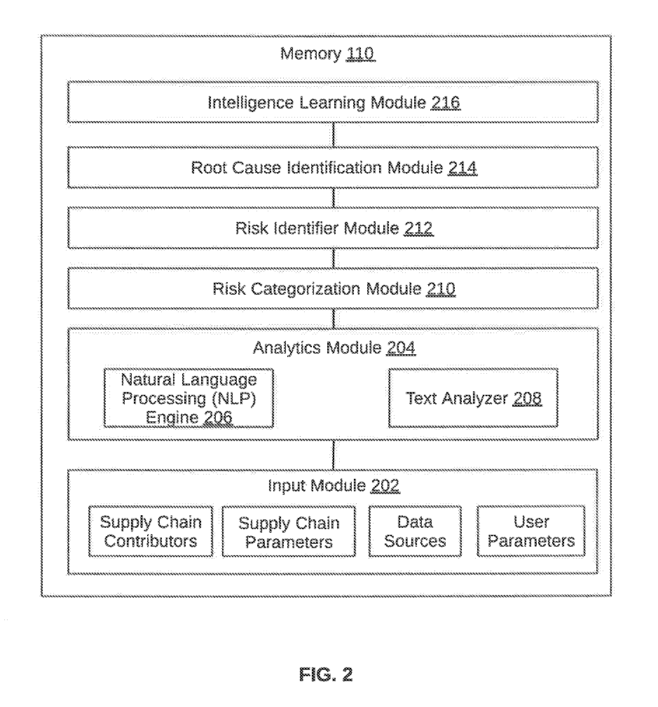

Memory 110 further includes various modules that enable root cause identification device 102 to identify root cause for risks in the supply chain network. These modules are explained in detail in conjunction with FIG. 2. Root cause identification device 102 may further include a display 112 having a User Interface (UI) 114 that may be used by a user or an administrator to provide inputs and to interact with root cause identification device 102. Display 112 may further be used to display result of various analysis performed while identifying root cause.

Referring now to FIG. 2, a block diagram of various modules within memory 110 of root cause identification device 102 configured to identify a root cause in a supply chain network, in accordance with an embodiment. Memory 110 includes an input module 202 that receive a plurality of supply chain inputs associated with the supply chain network. The plurality of supply chain inputs may include, but are not limited to supply chain contributors, supply chain parameters, and supply chain data sources, which communicate with root cause identification device 102 via network 106. The supply chain contributors may include, but are not limited to raw material suppliers, manufacturers, whole-salers, retailers, distributors, and the customers. Customers may vary depending upon the type of supply chain network. Further, the supply chain parameters include, but are not limited to supply, demand, transportation, process, storage, information, finance, and environment. The supply chain data sources are selected based on the supply chain parameters.

In addition to receiving the plurality of supply chain parameters, root cause identification device 102 receives user query as user parameters. Thereafter, an analytics module 204 analyses the user query using a Natural Language Processing (NLP) engine 206 and a text analyzer 208 to derive keywords, entities involved, and relationships between the keywords and the entities from the user query. A risk categorizing module 210 categorizes the user query into a risk category selected from a plurality of risk categories. Thereafter, risk categorizing module 210 creates a relationship mapping amongst one or more of a plurality of attributes associated with the risk category. Based on the risk category and the relationship mapping, a risk identifier module 212 identifies a risk in the supply chain network.

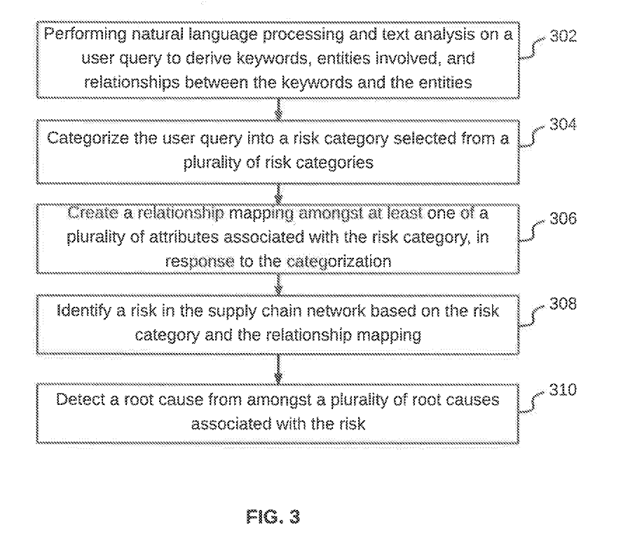

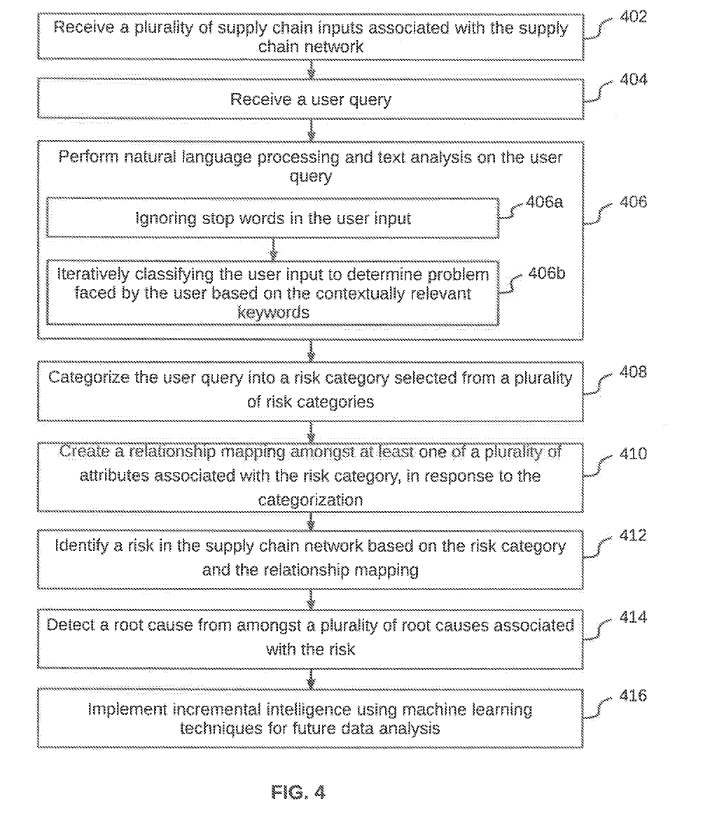

A root cause identification module 214 then detects a root cause from amongst a plurality of root causes associated with the risk using a causal analysis algorithm. Root cause identification module 214 identifies the root cause of the risk using Ngrams with the relationship mapping to arrive at the appropriate solution for minimizing the risk. This is further explained in detail in conjunction with FIG. 3. An intelligence learning module 216 implements incremental intelligence using machine learning techniques for future data analysis. Intelligence learning module 216 revises the relationship mapping and values associated with one or more of the plurality of attributes of the risk category based on how the root cause was identified and arrived at by root cause identification module 214. This is further explained in detail in conjunction with FIG. 4.

FIG. 3 illustrates a flowchart of a method of identifying a root cause associated with a risk in a supply chain network, in accordance with an embodiment. To initialize the system in the supply chain network, a plurality of supply chain inputs associated with the supply chain network are received. The plurality of supply chain inputs may include, but are not limited to supply chain contributors, supply chain parameters, and supply chain data sources, the supply chain data sources being selected based on the supply chain parameters. This is further explained in detail in conjunction with FIG. 4.

Root cause identification device 102 receives a user query. The user query denotes the exact problem description that the user is facing. The user query may include, but is not limited to one or more of an audio query and a text query. The user, for example, may log a ticket with the supply chain network. By way of an example, the ticket may include the following query: “I didn't get my Camera delivered still. The product ordered two weeks before.” By way of another example, the ticket may include the following query: “the camera lens is not functioning.” The ticket may have been logged either verbally through a user utterance on an audio call or may have been inputted in the form of text from one of plurality of computing devices 104.

At step 302, root cause identification device 102 performs natural language processing and text analysis on the user query. Natural language processing is used mostly to analyze user utterances. Natural language processing may also be applied to speech and text. In an embodiment, when it pertains to email prioritization, natural language processing may include sentence detection, tokenization, sentence tagging, parts of speech tagging, named entity recognition, and co-reference resolution. The natural language processing is used to scan the user query to recognize the necessary nouns, pronouns, and named entities in order to identify the exact problem description that the user is facing. Further, the text analysis is performed to scan content of the user utterance or text written by the user. Text analysis includes performing iterative classification of the user query to determine problem faced by the user based on the contextually relevant keywords. Text analysis also includes ignoring stop words in the user query to determine the problem faced by the user. Examples of stop words include, but are not limited to the, is, at, which, and on.

The natural language processing and the text analysis are performed to derive keywords, entities involved, and relationships between the keywords and the entities from the user query. In other words, keywords are extracted from the user query and a relevant context is also derived by determining relationship between the keywords and a central entity in the user query. By way of an example, when the user query is: “I didn't get my Camera delivered still. The product ordered two weeks before.” The keywords that are derived are: Camera, delivered, didn't get, two weeks and the derived or identified entity is “camera”. The relationship between these keywords and the entity is that that the camera didn't get delivered since two weeks. By way of another example, when the user query is: “the camera lens focus is not functioning properly,” the keywords that are derived are: Camera, lens, and not functioning and the entity is identified as: Camera. The relationship between the keywords and the entity is that lens focus of the camera is not functioning, where lens and focus are the attributes (or product features) associated with the camera and “not functioning” is the value of these attributes.

While deriving the keywords, entities, and relationships, stops words in the user query of this example, i.e., “I,” “my,” and “still,” are ignored. Moreover, because of the iterative classification, the text analysis algorithm learns to ignore descriptive words, when one of the examples of that descriptive word is also used in the user query. For example, the word “product” is a descriptive word in the context of the user query of this example. The word “camera,” which is a product is an example of the descriptive word “product” in the context of the user query of this example. Therefore, in this case, the text analysis algorithm along with the natural language processing is used to point the term “product’ to “camera.”

Root cause identification device 102, at step 304, categorizes the user query into a risk category selected from a plurality of risk categories. A set of objects are clustered into a risk category in such a way that objects in the same risk category are more similar to each other than to those in other risk categories. Categorizing includes finding a structure in a collection of unlabeled data. Each keyword is mapped into each of the plurality of risk categories based on the attributes and the properties of keywords and the risk categories. Further, similarity algorithms are used to calculate distance in order to check which keywords will be fit under each of the plurality of risk categories.

In an embodiment, in a product manufacturing supply chain network, supply chain risks may be categorized under three risk categories, i.e., an external to supply chain risk category, an internal to supply chain risk category, and a management related risk category. Each of these risk categories may be formed by grouping components or attributes associated with the product manufacturing supply chain network. This is depicted in Table 1.

TABLE 1

| Risk Category | Components/Attributes |
|---|---|
| External to supply chain | Finance, Environment |
| Internal to supply chain | Process, Storage, Information |
| Management Related | Supplier, Demand, Transportation |

When the keywords and entities are derived, root cause identification device 102 maps these keywords to the plurality of risk categories based on the attributes of these risk categories. By way of an example, when the user query is: “I didn't get my Camera delivered still. The product ordered two weeks before.” one of the keywords is: “delivery.” Thus, this maps to the “Management Related risk category,” as delivery is not a part of the supply chain, either external or internal. By way of another example, when the user query is: “the camera lens focus is not functioning properly,” this would be mapped to “Internal to supply chain category,” as this issue would be within the supply chain.

When the user query is categorized into one of the risk categories, that risk category and the associated attributes in the supply chain network are the only ones to be focused on. As a result, time to perform the analysis is reduced, as other risk categories can be ignored and no analysis is required to be performed for these risk categories and the associated components.

After the user query has been categorized into a risk category, root cause identification device 102, at step 306, creates a relationship mapping amongst one or more of a plurality of attributes associated with the risk category. By way of an example, the user query “the camera lens focus is not functioning properly” is categorized in the “Internal to supply chain category.” The attributes associated with this risk category are “Process, Storage and Information,” and are thus diagnosed to create a relationship mapping amongst one or more of these attributes.

Process may further have the following sub-attributes associated with it: manufacturing process and process flow. Similarly, storage may further have the following sub-attributes associated with it: storage infrastructure and storage requirements. Based on this, the relationship mapping may be created as: “Storage Infrastructure”+“Storage Requirements”→“Manufacturing Process.”

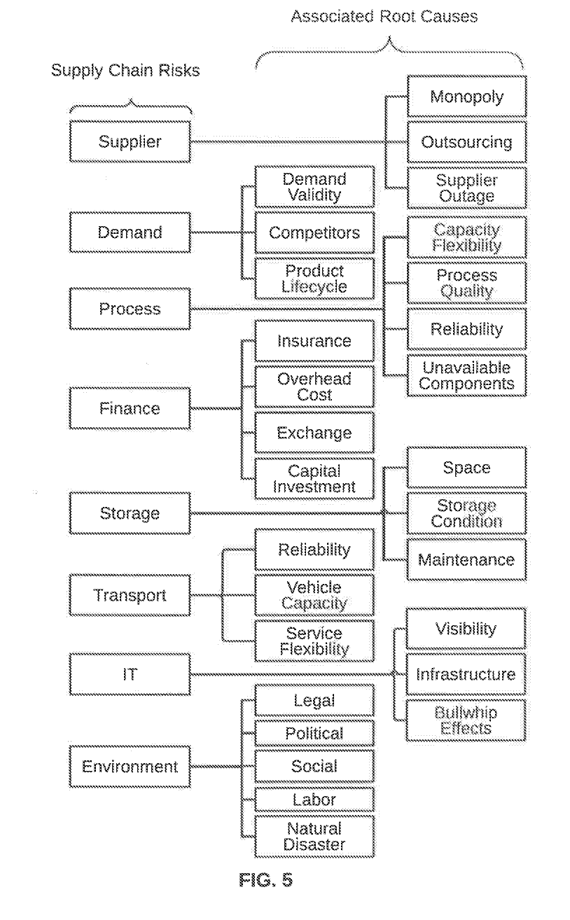

Based on the risk category and the relationship mapping, root cause identification device 102, at step 308, identifies a risk in the supply chain network for the user query. In continuation of the example above, the risk is identified as “Manufacturing Process.” Root cause identification device 102 then detects a root cause from amongst a plurality of root causes associated with the risk, at step 310. In continuation of the example above, based on the relationship mapping, one of storage infrastructure or storage requirements is identified as the root cause. The root cause needs to be fixed in order to resolve the risk in manufacturing process. In an embodiment, each risk has an associated set of root causes. By way of an example, for a product manufacturing supply chain network, for the risk due to the “Supplier” component, associated root causes may be one of monopoly, outsourcing, or supplier outage. Similar risk components and associated root causes for a product manufacturing supply chain network are depicted in FIG. 5. It will be apparent to a person skilled in the art that such mapping between risk components and associated root causes may be created for any type of supply chain network. In an embodiment, brainstorming and Pareto analysis may be used to derive the risk components and the associated root causes.

The proposed method identifies the supply chain risk by its own intelligence from the user query and diagnoses the root cause of the supply chain risk. Therefore, helps in improving profitability of the supply chain network. This method is a great time saving approach as it reduces manual efforts in tracking the customer ticket logs. The system is also an incremental learning system that meets customer satisfaction in a shorter turnaround time.

FIG. 4 illustrates a flowchart of a method of identifying a root cause associated with a risk in a supply chain network, in accordance with another embodiment. At step 402, root cause identification device 102 receives a plurality of supply chain inputs associated with the supply chain network. The plurality of supply chain inputs may include, but are not limited to supply chain contributors, supply chain parameters, and supply chain data sources. The supply chain contributors may include but are not limited to raw material suppliers, manufacturers, whole-salers, retailers, distributors, and the customers. Customers may vary depending upon the type of supply chain network. Further, the supply chain parameters include, but are not limited to supply, demand, transportation, process, storage, information, finance, and environment. The supply chain data sources are selected based on the supply chain parameters.

Thereafter, at step 404, root cause identification device 102 receives a user query. Root cause identification device 102 performs natural language processing and text analysis on the user query, at step 406. To this end, at step 406a, root cause identification device 102 ignores stop words in the user query to derive keywords, entities, and relationship between the keywords and the entities. Root cause identification device 102 then iteratively classifies the user query to determine problem faced by the user based on the relationship between the keywords and the entities at step 406b. This has been explained in conjunction with FIG. 3.

At step 408, root cause identification device 102 categorizes the user query into a risk category selected from a plurality of risk categories. Thereafter, at step 410, root cause identification device 102 creates a relationship mapping amongst one or more of a plurality of attributes associated with the risk category. At step 412, root cause identification device 102 identifies a risk in the supply chain network based on the risk category and the relationship mapping. Root cause identification device 102 then detects a root cause from amongst a plurality of root causes associated with the risk at step 414. This has been explained in detail in conjunction with FIG. 3.

At step 416, root cause identification device 102 implements incremental intelligence using machine learning techniques for future data analysis. Root cause identification device 102 uses machine learning techniques to monitor the entire system and to learn user's behavior. Root cause identification device 102 captures all user queries that are received and creates a mapping of these user queries with the identified risks and subsequently identified root causes. This enables incremental learning for root cause identification device 102. As a result, for future queries entered by the user, a root cause can be determined promptly using the incremental learning and stored data. For example, if a user query is similar to the previously stored data, the risk detection device will directly provide the solution using the incremental learning without any processing. As a result, the problem faced by the user can be resolved promptly, thereby, improving user experience and increasing efficiency of the supply chain network.

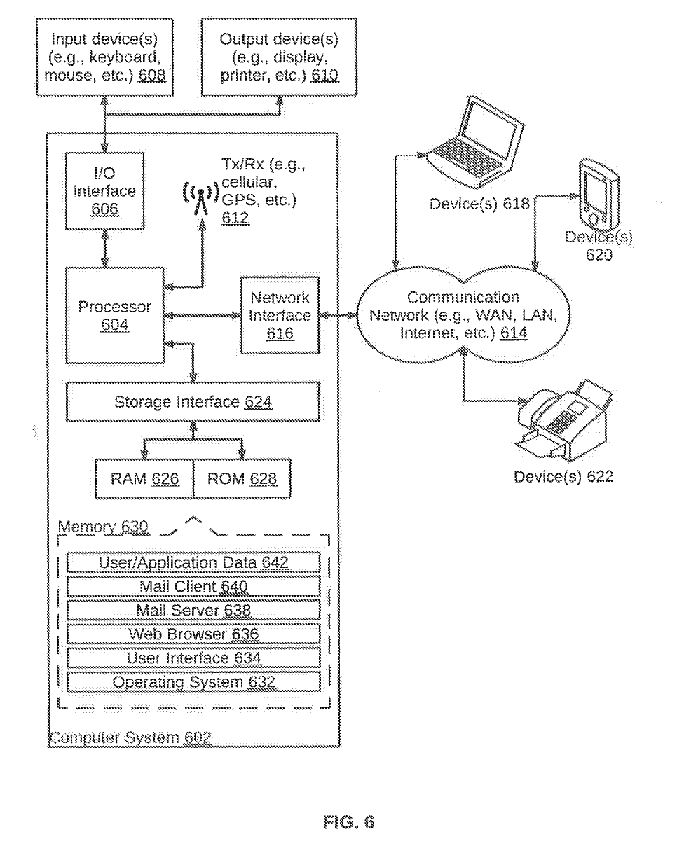

FIG. 6 is a block diagram of an exemplary computer system for implementing various embodiments. Computer system 602 may comprise a central processing unit (“CPU” or “processor”) 604. Processor 604 may comprise at least one data processor for executing program components for executing user- or system-generated requests. A user may include a person, a person using a device such as such as those included in this disclosure, or such a device itself. Processor 604 may include specialized processing units such as integrated system (bus) controllers, memory management control units, floating point units, graphics processing units, digital signal processing units, etc. Processor 604 may include a microprocessor, such

as AMD® ATHLON® microprocessor, DURON® microprocessor OR OPTERON® microprocessor, ARM's application, embedded or secure processors, IBM® POWERPC®, INTEL'S CORE® processor, ITANIUM® processor, XEON® processor, CELERON® processor or other line of processors, etc. Processor 604 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 604 may be disposed in communication with one or more input/output (I/O) devices via an I/O interface 606. I/O interface 606 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using I/O interface 606, computer system 602 may communicate with one or more I/O devices. For example, an input device 608 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. An output device 610 may be a printer, fax machine, video display (e.g., cathode ray tube (CRT), liquid crystal display (LCD), light-emitting diode (LED), plasma, or the like), audio speaker, etc. In some embodiments, a transceiver 612 may be disposed in connection with processor 604. Transceiver 612 may facilitate various types of wireless transmission or reception. For example, transceiver 612 may include an antenna operatively connected to a transceiver chip (e.g., TEXAS® INSTRUMENTS WILINK WL1283® transceiver, BROADCOM® BCM45501UB8® transceiver, INFINEON TECHNOLOGIES® X-GOLD 618-PMB9800® transceiver, or the like), providing IEEE 802.11a/b/g/n, Bluetooth, FM, global positioning system (GPS), 2G/3G HSDPA/HSUPA communications, etc.

In some embodiments, processor 604 may be disposed in communication with a communication network 614 via a network interface 616. Network interface 616 may communicate with communication network 614. Network interface 616 may employ connection protocols including, without limitation, direct connect, Ethernet (e.g., twisted pair 50/500/5000 Base T), transmission control protocol/internet protocol (TCP/IP), token ring, IEEE 802.11a/b/g/n/x, etc. Communication network 614 may include, without limitation, a direct interconnection, local area network (LAN), wide area network (WAN), wireless network (e.g., using Wireless Application Protocol), the Internet, etc. Using network interface 616 and communication network 614, computer system 602 may communicate with devices 618, 620, and 622. These devices may include, without limitation, personal computer(s), server(s), fax machines, printers, scanners, various mobile devices such as cellular telephones, smartphones (e.g., APPLE® IPHONE® smartphone, BLACKBERRY® smartphone, ANDROID® based phones, etc.), tablet computers, eBook readers (AMAZON® KINDLE® ereader, NOOK® tablet computer, etc.), laptop computers, notebooks, gaming consoles (MICROSOFT® XBOX® gaming console, NINTENDO® DS® gaming console, SONY® PLAYSTATION® gaming console, etc.), or the like. In some embodiments, computer system 602 may itself embody one or more of these devices.

In some embodiments, processor 604 may be disposed in communication with one or more memory devices (e.g., RAM 626, ROM 628, etc.) via a storage interface 624. Storage interface 624 may connect to memory 630 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

Memory 630 may store a collection of program or database components, including, without limitation, an operating system 632, user interface application 634, web browser 636, mail server 638, mail client 640, user/application data 642 (e.g., any data variables or data records discussed in this disclosure), etc. Operating system 632 may facilitate resource management and operation of computer system 602. Examples of operating systems 632 include, without limitation, APPLE® MACINTOSH® OS X platform, UNIX platform, Unix-like system distributions (e.g., Berkeley Software Distribution (BSD), FreeBSD, NetBSD, OpenBSD, etc.), LINUX distributions (e.g., RED HAT®, UBUNTU®, KUBUNTU®, etc.), IBM® OS/2 platform, MICROSOFT® WINDOWS® platform (XP, Vista/7/8, etc.), APPLE® IOS® platform, GOOGLE® ANDROID® platform, BLACKBERRY® OS platform, or the like. User interface 634 may facilitate display, execution, interaction, manipulation, or operation of program components through textual or graphical facilities. For example, user interfaces may provide computer interaction interface elements on a display system operatively connected to computer system 602, such as cursors, icons, check boxes, menus, scrollers, windows, widgets, etc. Graphical user interfaces (GUIs) may be employed, including, without limitation, APPLE® Macintosh® operating systems' AQUA® platform, IBM® OS/2® platform, MICROSOFT® WINDOWS® platform (e.g., AERO® platform, METRO® platform, etc.), UNIX X-WINDOWS, web interface libraries (e.g., ACTIVEX® platform, JAVA® programming language, JAVASCRIPT® programming language, AJAX® programming language, HTML, ADOBE® FLASH® platform, etc.), or the like.

In some embodiments, computer system 602 may implement a web browser 636 stored program component. Web browser 636 may be a hypertext viewing application, such as MICROSOFT® INTERNET EXPLORER® web browser, GOOGLE® CHROME® web browser, MOZILLA® FIREFOX® web browser, APPLE® SAFARI® web browser, etc. Secure web browsing may be provided using HTTPS (secure hypertext transport protocol), secure sockets layer (SSL), Transport Layer Security (TLS), etc. Web browsers may utilize facilities such as AJAX, DHTML, ADOBE® FLASH® platform, JAVASCRIPT® programming language, JAVA® programming language, application programming interfaces (APis), etc. In some embodiments, computer system 602 may implement a mail server 638 stored program component. Mail server 638 may be an Internet mail server such as MICROSOFT® EXCHANGE® mail server, or the like. Mail server 638 may utilize facilities such as ASP, ActiveX, ANSI C++/C#, MICROSOFT .NET® programming language, CGI scripts, JAVA® programming language, JAVASCRIPT® programming language, PERL® programming language, PHP® programming language, PYTHON® programming language, WebObjects, etc. Mail server 638 may utilize communication protocols such as internet message access protocol (IMAP), messaging application programming interface (MAPI), Microsoft Exchange, post office protocol (POP), simple mail transfer protocol (SMTP), or the like. In some embodiments, computer system 602 may implement a mail client 640 stored program component. Mail client 640 may be a mail viewing application, such as APPLE MAIL® mail client, MICROSOFT ENTOURAGE® mail client, MICROSOFT OUTLOOK® mail client, MOZILLA THUNDERBIRD® mail client, etc.

In some embodiments, computer system 602 may store user/application data 642, such as the data, variables, records, etc. as described in this disclosure. Such databases may be implemented as fault-tolerant, relational, scalable, secure databases such as ORACLE® database OR SYBASE® database. Alternatively, such databases may be implemented using standardized data structures, such as an array, hash, linked list, struct, structured text file (e.g., XML), table, or as object-oriented databases (e.g., using OBJECTSTORE® object database, POET® object database, ZOPE® object database, etc.). Such databases may be consolidated or distributed, sometimes among the various computer systems discussed above in this disclosure. It is to be understood that the structure and operation of the any computer or database component may be combined, consolidated, or distributed in any working combination.

Various embodiments of the invention provide methods and devices for identifying root causes associated with risks in supply chain networks. The proposed method identifies the supply chain risk by its own intelligence from the user query and diagnoses the root cause of the supply chain risk. Therefore, helps in improving profitability of the supply chain network. This method is a great time saving approach as it reduces manual efforts in tracking the customer ticket logs. The system is also an incremental learning system that meets customer satisfaction in a shorter turnaround time.

The specification has described methods and devices for identifying root causes associated with risks in supply chain networks. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of identifying root cause associated with risks in a supply chain network, the method comprising:
performing, by a root cause identification device, natural language processing and text analysis on a user query to derive keywords, entities involved, and relationships between the keywords and the entities;
categorizing, by the root cause identification device, the user query into a risk category selected from a plurality of risk categories;
creating, by the root cause identification device, a relationship mapping amongst at least one of a plurality of attributes associated with the risk category, in response to the categorization;
identifying, via the root cause identification device, a risk in the supply chain network based on the risk category and the relationship mapping; and
detecting, via the root cause identification device, a root cause from amongst a plurality of root causes associated with the risk.

2. The method of claim 1 further comprising receiving a user query, the user query comprising at least one of an audio query and a text query.

3. The method of claim 1 further comprising receiving a plurality of supply chain inputs associated with the supply chain network.

4. The method of claim 3, wherein the plurality of supply chain inputs are selected from a group comprising supply chain contributors, supply chain parameters, and supply chain data sources, the supply chain data sources being selected based on the supply chain parameters.

5. The method of claim 4, wherein the supply chain parameters are selected from a group comprising supply, demand, transportation, process, storage, information, finance, environment.

6. The method of claim 1, wherein performing the text analysis comprises iteratively classifying the user query to determine problem faced by the user based on the contextually relevant keywords derived.

7. The method of claim 1, wherein performing the text analysis comprises ignoring stop words in the user query.

8. The method of claim 1, wherein the plurality of risk categories comprises at least one of an external to supply chain category, an internal to supply chain category, and a management related category.

9. The method of claim 1 further comprising implementing incremental intelligence using machine learning techniques for future data analysis.

10. A root cause identification device for identifying root cause associated with risks in a supply chain network, the root cause identification device comprises:
a processor; and
a memory communicatively coupled to the processor, wherein the memory stores processor instructions, which, on execution, causes the processor to:
perform natural language processing and text analysis on a user query to derive keywords, entities involved, and relationships between the keywords and the entities;
categorize the user query into a risk category selected from a plurality of risk categories;
create a relationship mapping amongst at least one of a plurality of attributes associated with the risk category, in response to the categorization;
identify a risk in the supply chain network based on the risk category and the relationship mapping; and
detect a root cause from amongst a plurality of root causes associated with the risk.

11. The root cause identification device of claim 10, wherein the processor instructions further cause the processor to receive a user query comprising at least one of an audio query and a text query.

12. The root cause identification device of claim 10, wherein the processor instructions further cause the processor to receive a plurality of supply chain inputs associated with the supply chain network.

13. The root cause identification device of claim 12, wherein the plurality of supply chain inputs are selected from a group comprising supply chain contributors, supply chain parameters, and supply chain data sources, the supply chain data sources being selected based on the supply chain parameters.

14. The root cause identification device of claim 13, wherein the supply chain parameters are selected from a group comprising supply, demand, transportation, process, storage, information, finance, environment.

15. The root cause identification device of claim 10, wherein to perform the text analysis the processor instructions further cause the processor to iteratively classify the user query to determine problem faced by the user based on the contextually relevant keywords derived.

16. The root cause identification device of claim 10, wherein to perform the text analysis the processor instructions further cause the processor to ignore stop words in the user query.

17. The root cause identification device of claim 10, wherein the plurality of risk categories comprises at least one of an external to supply chain category, an internal to supply chain category, and a management related category.

18. The root cause identification device of claim 10, wherein the processor instructions further cause the processor to implement incremental intelligence using machine learning techniques for future data analysis.

19. A non-transitory computer-readable storage medium having stored thereon, a set of computer-executable instructions causing a computer comprising one or more processors to perform steps comprising:
performing, by a root cause identification device, natural language processing and text analysis on a user query to derive keywords, entities involved, and relationships between the keywords and the entities;
categorizing, by the root cause identification device, the user query into a risk category selected from a plurality of risk categories;
creating, by the root cause identification device, a relationship mapping amongst at least one of a plurality of attributes associated with the risk category, in response to the categorization;
identifying, via the root cause identification device, a risk in the supply chain network based on the risk category and the relationship mapping; and
detecting, via the root cause identification device, a root cause from amongst a plurality of root causes associated with the risk.
